(19) United States
(12) Patent Application Publication
(10) Pub. No.: US 2009/0314438 A1
(43) Pub. Date: Dec. 24, 2009

(54) Supporting plate peeling apparatus

(75) Inventors: Yasumasa Iwata, Kawasaki-shi (JP); Akihiko Nakamura, Kawasaki-shi (JP); Yoshihiro Inao, Kawasaki-shi (JP)

Correspondence Address: HARNESS, DICKEY & PIERCE, P.L.C., P.O. BOX 8910, RESTON, VA, 20195, US

(73) Assignee: TOKYO OHKA KOGYO CO., LTD.

(21) Appl. No.: 12/457,139

(22) Filed: Jun. 2, 2009

(30) Foreign Application Priority Data
Jun. 18, 2008 (JP) 2008-159297

(51) Int. Cl. B32B 38/10

(52) U.S. Cl. 156/584

(57) ABSTRACT

A supporting plate peeling apparatus in accordance with the present invention has removal means for removing an adhesive agent remaining on a side of a wafer from which a supporting plate has been peeled off, which adhesive agent is removed after (i) a supporting plate which supports a wafer reduced in thickness has been peeled off from the wafer and (ii) the side from which the supporting plate has been peeled off is washed with a washing liquid. The supporting plate peeling apparatus in accordance with the present invention is a supporting plate peeling apparatus which can remove the adhesive agent that remains on the side of the wafer from which the supporting plate has been peeled off that could not be completely removed just by the washing liquid, and which allows satisfactory completion of a peeling step. Hence, a supporting plate peeling apparatus is provided, which peels off a supporting plate for supporting a wafer, while not causing the side of the wafer from which the support plate has been peeled off to deteriorate.

This Nonprovisional application claims priority under 35 U.S.C. § 119(a) on Patent Application No. 2008-159297 filed in Japan on Jun. 18, 2008, the entire contents of which are hereby incorporated by reference.

### TECHNICAL FIELD

The present invention relates to a supporting plate peeling apparatus for peeling off, from a wafer, a supporting plate adhered to the wafer with an adhesive agent, and more specifically, relates to a supporting plate peeling apparatus including removal means for removing an adhesive agent that remains on a side of a wafer from which a supporting plate has been peeled off.

### BACKGROUND ART

High-functioning of mobile phones, digital AV apparatuses, IC cards and the like has caused an increase in demand for high integration of chips in a package by reducing size and thickness of a semiconductor silicon chip (hereinafter referred to as “chip”) thus mounted in the package. In order to accomplish high integration of the chips inside the package, it is required to reduce the thickness of the chip to not more than 150 μm.

However, a semiconductor wafer (hereinafter referred to as “wafer”) which serves as a base of the chip is reduced in thickness by grinding; its strength therefore becomes weak, thereby causing the wafer to easily crack and warp. Moreover, it is difficult to carry in an automated manner a wafer that is weak in strength due to the reduction of thickness; this causes the need to carry the wafer by people's hands, which makes handling of the wafer complex.

In response to this problem, a wafer support system has been developed, which attaches a plate made of glass, hard plastic or the like that is called a supporting plate (hereinafter referred to as “support plate”) to the wafer which is to be grinded, so as to maintain the strength of the wafer, and prevent generation of a crack and warping of the wafer. The wafer support system maintains the strength of the wafer; therefore it is possible to automate carrying of the semiconductor wafer that is reduced in thickness.

The wafer and the support plate are adhered together by use of an adhesive tape, thermoplastic resin, an adhesive agent, or the like. Thereafter, the support plate is peeled off from the wafer, before the wafer is diced. The support plate is peeled off from the wafer by the following methods for example: in a case where an adhesive tape is used for adhering the wafer and the support plate, the wafer is ripped off from the support plate; in a case where the thermoplastic resin is used, the resin is heated so as to melt the resin; and in a case where the adhesive agent is used, the adhesive agent is melted by use of a solution. For example, Patent Literature 1 (Japanese Patent Application Publication, Tokukai, No. 2006-135272 A (Publication Date: May 25, 2006)) discloses a technique that a wafer and a support plate are adhered together by use of an adhesive agent, and the wafer is peeled off from the support plate by melting the adhesive agent with a solvent. When peeling off the support plate, a laminate is held so that the support plate is positioned as its highest layer, and the solvent for melting the adhesive agent is supplied via a through hole of the support plate so as to melt the adhesive agent which adheres a substrate and the support plate.

Moreover, the wafer is peeled off from the support plate after another supporting body such as a dicing tape is adhered to the other side of the wafer depending on a film thickness of the wafer. This is because the film thickness of the wafer is thin and has a low strength; as a result, a crack is easily generated. That is to say, a laminate made of a dicing tape, a wafer, and a support plate is once formed; thereafter the wafer is peeled off from the support plate.

It is known that, upon peeling off of the support plate from the wafer as described above, a side of the wafer from which the support plate has been peeled off is washed with a washing liquid. Conventionally, it has been believed that this process removes any adhesive agent remaining on the wafer, which did not completely melt by the solvent. However, the inventors of the present invention found that the adhesive agent still tends to remain on the side of wafer from which the support plate has been peeled off, even after the wafer has been washed with the washing liquid. Such adhesive agent residue may greatly impede improvement in performance of the wafer having the increased demand for high performance.

### SUMMARY OF INVENTION

An object of the present invention is to provide a supporting plate peeling apparatus for peeling off a supporting plate, which supporting plate peeling apparatus is capable of removing an adhesive agent that remains on a side of a wafer from which the supporting plate has been peeled off even after the wafer has been washed with a washing liquid.

A supporting plate peeling apparatus in accordance with the present invention includes: peeling means for peeling off a wafer from a supporting plate, the wafer being adhered to the supporting plate by use of an adhesive agent; washing means for washing, by use of a solvent, the adhesive agent remaining on a supporting plate side of the wafer from which the supporting plate has been peeled off by the peeling means; and removal means for removing, by dry processing, the adhesive agent remaining on the supporting plate side of the wafer which has been washed by the washing means.

With a supporting plate peeling apparatus in accordance with the present application, adhesive agent residue is removed by dry processing at removal means, which adhesive agent residue could not be completely removed by washing with a washing liquid after the support plate has been peeled off from the wafer reduced in thickness and fixed to a dicing tape, and which support plate is peeled off by melting an adhesive agent layer.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1(a) is a perspective view illustrating an arrangement of a laminate as a processing object of a support plate peeling apparatus which is one embodiment of a supporting plate peeling apparatus in accordance with the present invention, and FIG. 1(b) is a cross sectional view illustrating a cross sectioned state of the laminate on cross section line A-A′ shown in FIG. 1(a).

FIG. 2

FIG. 2 is a perspective view illustrating a formation step of the laminate illustrated in FIG. 1.

FIG. 3

FIG. 3 is an explanatory view illustrating one part of an arrangement of a support plate peeling apparatus which is one embodiment of a supporting plate peeling apparatus in accordance with the present invention.

FIG. 4

FIG. 4 is an explanatory view illustrating one part of an arrangement of a support plate peeling apparatus which is one embodiment of a supporting plate peeling apparatus in accordance with the present invention.

### DESCRIPTION OF EMBODIMENTS

### First Embodiment

One embodiment of a supporting plate peeling apparatus in accordance with the present invention is described below with reference to the attached drawings.

A supporting plate peeling apparatus (hereinafter referred to as “support plate peeling apparatus”) includes: peeling means for peeling off a wafer from a supporting plate (hereinafter referred to as “support plate”), the wafer being adhered to the support plate by use of an adhesive agent; washing means for washing, by use of a solvent, the adhesive agent remaining on a supporting plate side of the wafer from which the supporting plate has been peeled off by the peeling means; and removal means for removing, by dry processing, the adhesive agent remaining on the supporting plate side of the wafer (hereinafter referred to as “side from which the supporting plate has been peeled off”) which has been washed by the washing means.

The following description explains a laminate including a support plate which is to be peeled off by the support plate peeling apparatus of the present embodiment.

<Laminate>

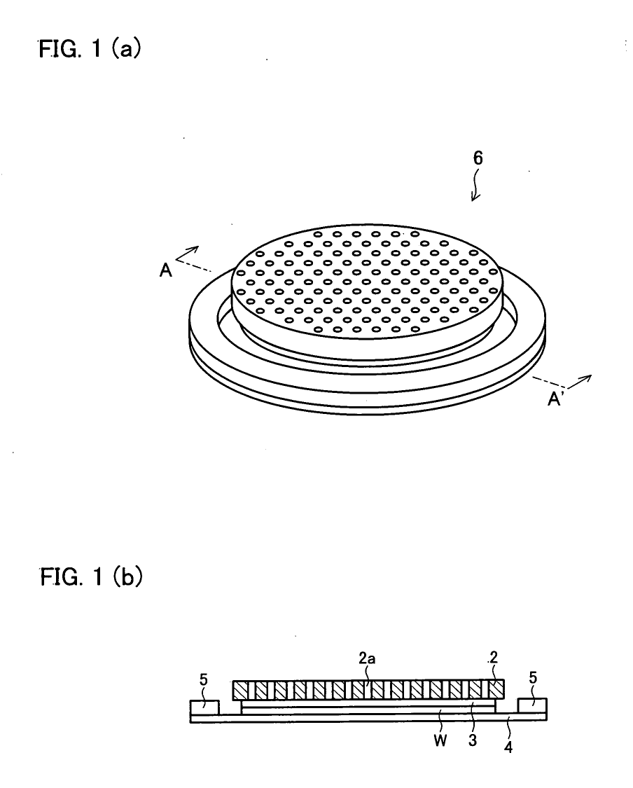

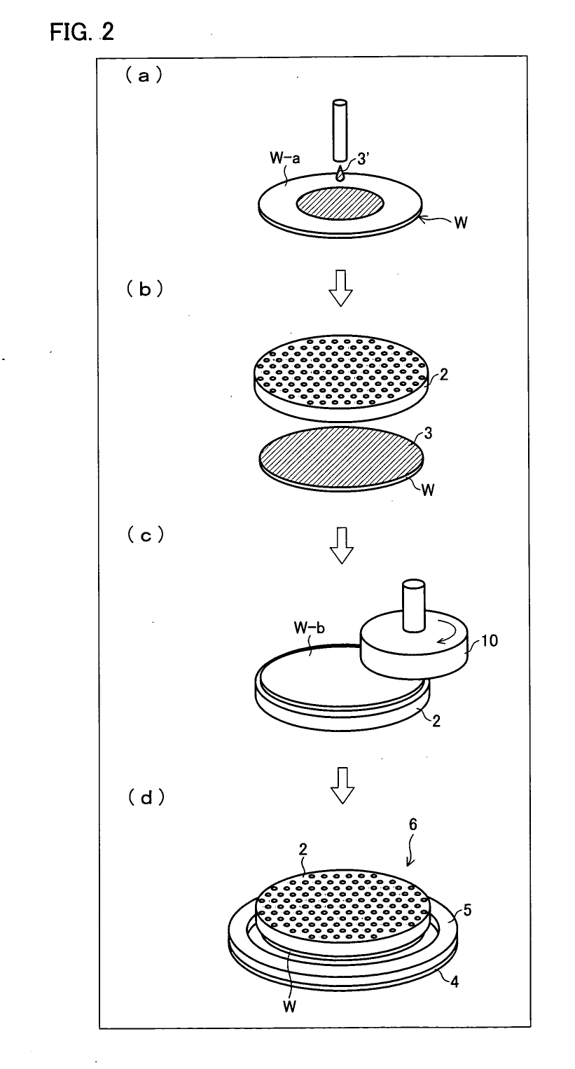

FIG. 1(a) and FIG. 1(b) are explanatory views illustrating an arrangement of a laminate, and FIG. 2 is an explanatory view of a formation step of the laminate.

FIG. 1(a) is a perspective view of a laminate 6. FIG. 1(b) is a cross sectional view illustrating a cross section state of the laminate 6, at a cross section line A-A′ shown in FIG. 1(a). The laminate 6 includes, as illustrated in FIG. 1(b), a wafer W, a support plate 2, an adhesive agent layer 3, a dicing tape 4, and a dicing frame 5. The wafer W is adhered to the support plate 2 via the adhesive agent layer 3. A more specific arrangement is as described as follows.

The wafer W is a substrate on which a circuit (element) is formed on a side where the support plate 2 is adhered. A substrate made of conventionally known material such as a semiconductor or the like is usable as the wafer W. The wafer W is subjected to a grinding process later described for reducing its thickness, and is made to a thickness exceeding 0 μm but not more than 150 μm; preferably in a range of 10 μm to 150 μm.

The support plate 2 is a member for supporting the wafer W in a step of forming the wafer W reduced in thickness from a thick-film form. An iron-nickel alloy (nickel 36% alloy: invar) having a diameter larger than that of the wafer W (radius of 2 mm) and having a thickness in a range of 500 μm to 1000 μm as illustrated in FIG. 1(a) and FIG. 1(b), for example, may be used as the support plate 2. However, the present invention is not limited to this; for example, the diameter may be the same as the wafer W, and the support plate 2 may be made of ceramics or glass.

The support plate 2 has a plurality of through holes 2a as illustrated in FIG. 1(b), which penetrate through the support plate 2 in a thickness direction. The through holes 2a are holes for supplying, to the adhesive agent layer 3 provided between the support plate 2 and the wafer W, a solvent for melting the adhesive agent layer 3 to peel off the support plate 2 adhered to the wafer W. Each of the through holes 2a have, for example, a diameter of 0.5 mm and a pitch of 0.7 mm on the support plate 2. The diameter and the formation pitch of the through holes 2a are not limited to the aforementioned value, however the diameter and the formation pitch are suitably in the following ranges: a diameter in a range of 0.3 mm to 0.5 mm, and a pitch of the through holes in a range of 0.5 mm to 1.0 mm.

The dicing tape 4 has a base film made of resin film such as PVC (polyvinyl chloride), polyolefin, polypropylene, and the like. An adhesive layer is provided on one side of the dicing tape 4 so that the wafer W can be adhered to the dicing tape 4. As illustrated in FIG. 1(b), the dicing tape 4 has a larger surface area than that of the wafer W later described. Therefore, when the wafer W is adhered on the dicing tape 4, a part of the dicing tape 4 is exposed around an outer edge of the wafer W.

The dicing frame 5 prevents loosening of the dicing tape 4.

The following description explains a formation step of the laminate 6.

In forming the laminate 6, as illustrated in FIG. 2, first, an adhesive agent liquid 3′ is applied on a side W-a on which the support plate is adhered (later a side W-a from which the support plate has been peeled off) of the wafer W ((a) of FIG. 2). Application may be carried out by use of a spinner, for example, however how the adhesive agent liquid 3′ is applied is not limited to this. The adhesive agent liquid may be any adhesive agent liquid provided that it has (i) a certain solubility with the solvent used in the peeling processing later described to such a degree that the support plate 2 can be peeled off, and (ii) a property that the adhesive agent remaining on the side of the wafer from which the support plate 2 has been peeled off may be removed by the processing of removing the adhesive agent. More specifically, a novolac-type phenol resin material adhesive agent, an acrylic resin adhesive agent, a polyvinyl alcohol adhesive agent, or the like may be used.

Next, the adhesive agent liquid is preliminary dried so as to reduce fluidity. This allows maintaining of shape as the adhesive agent layer 3. The preliminary drying is carried out by use of an oven, and for example, the adhesive agent liquid is heated at 80° C. for 5 minutes. The adhesive agent layer has a thickness that is determined in regards to unevenness of the circuit formed on a surface of the wafer W. If a required thickness cannot be obtained by one application, the application and preliminary drying are repetitively carried out for a plurality of times. In this case, the preliminary drying of the adhesive agent layer other than the top layer is strengthened in degree of drying so that the adhesive agent does not have fluidity.

The support plate 2 is adhered to the wafer W on which the adhesive agent layer 3 of a predetermined thickness is formed as described above ((b) of FIG. 2). The adhering of the wafer W to the support plate 2 may be carried out by use of an adhering machine. An arrangement of the adhering machine is not particularly limited, and is sufficiently arranged as long as the wafer W and the support plate 2 are positioned in predetermined positions so as to face each other, and are adhered together by applying pressure thereto. The adhering machine may have means for heating the support plate 2 upon application of pressure.

Subsequently, the wafer W is reduced in thickness by grinding a back side W-b of the wafer W by use of a grinder 10 ((c) of FIG. 2).

After providing, if necessary, a circuit and the like to the back side W-b of the wafer W reduced in thickness, the back side W-b is positioned so as to face the dicing tape 4, and is fixed to the dicing tape 4 ((d) of FIG. 2).

The laminate arranged as such serves as the processing object of the support plate peeling apparatus of the present embodiment.

The following description explains an arrangement of the support plate peeling apparatus and its peeling process.

<Support Plate Peeling Apparatus>

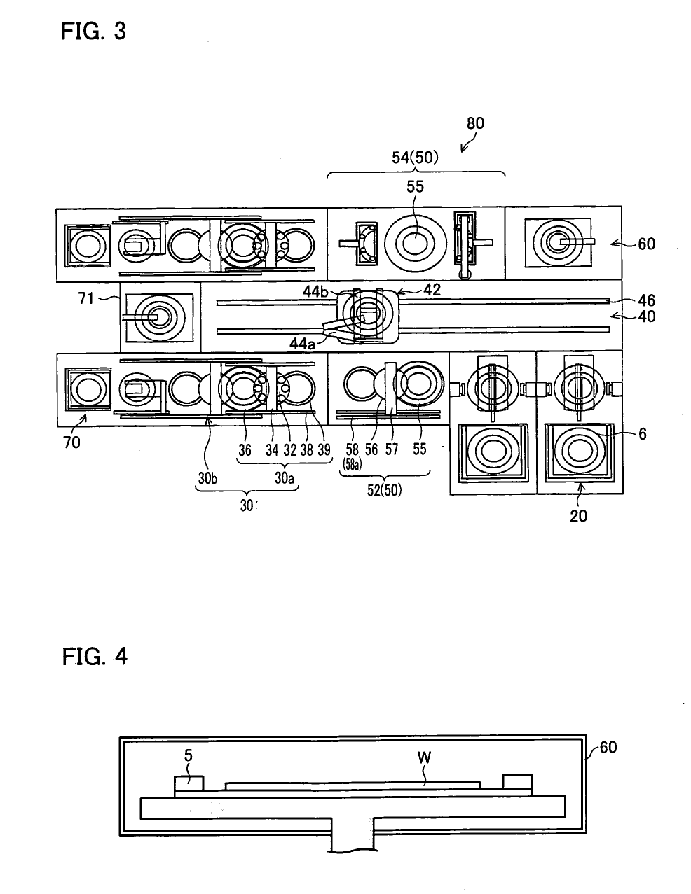

FIG. 3 is an explanatory view illustrating an arrangement of a support plate peeling apparatus of the present embodiment. The support plate peeling apparatus is used for peeling off the support plate 2 illustrated in FIG. 1(a) and FIG. 1(b), which support plate 2 is adhered to a side W-a of the wafer W reduced in thickness. Hence, a support plate peeling apparatus 80 at least includes, as illustrated in FIG. 3, a laminate containing section 20 which contains the laminate 6, peeling means 30, carrying means 40, washing means 50, and removal means 60.

(Peeling Means)

The peeling means 30 is an arrangement for supplying a solvent to the adhesive agent layer 3, which solvent melts the adhesive agent layer 3. Also, the peeling means, after the adhesive agent layer 3 is melted or is sufficiently degraded in adhesive strength, peels off the support plate 2 adhered to the side W-a of the wafer W, which wafer W is reduced in thickness, from the side W-a of the wafer W from which the support plate 2 is to be peeled off.

More specifically, the peeling means 30 includes a melting processing body 30a and a support plate carrier 30b.

The melting processing body 30a includes: a solvent injection plate 32; holder moving means 34 which holds the solvent injection plate 32 and allows movement of the held solvent injection plate 32 in a vertical direction; and a processing board 36 on which the laminate 6 is placed. Furthermore, it is preferable to include horizontally moving means 38, which allows in-plane (horizontal plane) movement of the solvent injection plate 32. This allows the solvent injection plate 32 to standby at a position that does not overlap with the processing board 36 when the support plate peeling apparatus 80 is seen as a plan view as illustrated in FIG. 1. This mode allows suppression of unintended supplying of the solvent when the laminate 6 is placed on the processing board 36.

That is to say, before the laminate 6 is placed on the processing board 36, the solvent injection plate 32 standbys at a standby position 39 different from a processing position; and after the laminate 6 is placed on the processing board 36, the solvent injection plate 32 is moved to a position right above the laminate 6 by the horizontally moving means 38. Subsequently, the solvent injection plate 32 is moved to a position which provides an appropriate distance between the laminate 6, by the holder moving means 34. Thereafter, the processing is carried out.

The solvent injection plate 32 has an opposing surface corresponding to the laminate 6. The opposing surface has a solvent supply hole (not illustrated) for supplying the solvent via the through holes of the support plate 2 and a solvent absorbing hole (not illustrated) for absorbing the solvent supplied. The solvent injection plate 32 is not particularly limited in its arrangement, as long as the solvent injection plate 32 can supply the solvent in such a manner that the solvent does not adhere to the dicing tape 4 exposed at the outer sides of the support plate 2 when seen as a plan view (see FIG. 1(b)). For example, the opposing surface may have the solvent supply hole at a center of the opposing surface, and the solvent absorbing hole at a position farthest from the center of the opposing surface, so as to prevent the solvent from adhering to the dicing tape 4 while supplying and absorbing the solvent. Another example is that a projecting part may be provided along an outer periphery of the solvent injection plate 32 so as to shorten a distance to the laminate 6, thereby preventing the solvent to physically disperse. Moreover, an ultrasonic wave generator may be provided to the solvent injection plate 32 for enhancing permeation of the solvent to the adhesive.

The support plate 2 which is made in a peelable state from the wafer W is carried to the support plate containing section 70 which contains the support plate, by the support plate carrier 30b.

A conventionally known solvent may be used for the solvent, such as one used as an adhesive agent liquid, which encompass for example: water; ketones such as acetone, methyl ethyl ketone, cyclohexanone, methyl isoamyl ketone, and 2-heptanone; polyvalent alcohols and its derivatives such as a monomethyl ether, monoethyl ether, monopropyl ether, monobutyl ether, or monophenyl ether of ethylene glycol, ethylene glycol monoacetate, diethylene glycol, diethylene glycol monoacetate, propylene glycol, propylene glycol monoacetate, dipropylene glycol or dipropylene glycol monoacetate; cyclic ethers such as dioxane; and ethers such as methyl lactate, ethyl lactate, methyl acetate, ethyl acetate, butyl acetate, methyl pyruvate, ethyl pyruvate, methyl methoxypropionate, and ethyl ethoxypropionate, and a combination thereof. These may be used with respect to the adhesive agent. Particularly, when an acrylic adhesive agent is used, it is preferable to use propylene glycol monomethyl ether acetate (PGMEA), or 2-heptanone (MAK) as the solvent, and when a polyvinyl alcoholic adhesive is used, it is preferable to use water as the solvent.

In order to improve processing efficiency, it is preferable to provide a plurality of melting processing bodies 30a to the support plate peeling apparatus. In this case, it is preferable to provide the melting processing bodies 30a so as to sandwich a traveling path 46 in the carrying means 40 as illustrated in FIG. 3, for efficient processing.

The wafer W from which the support plate 2 has been peeled off by the peeling means 30 as such is carried to washing means 50 by the carrying means 40. The following explanation describes the carrying means 40.

(Carrying Means)

The carrying means 40 has functions of (i) holding and carrying the laminate 6 to the peeling means 30, (ii) carrying the wafer W from the peeling means 30 to the washing means 50, and (iii) carrying the wafer W from the washing means 50 to the removal means 60.

The carrying means 40 includes a carrying robot 42 and a traveling path 46 which enables linear traveling. The carrying robot 42, more specifically, is rotatable at its axis, and has two connection arms 44a and a hand 44b. The connection arms 44a flexibly move in a rotational movement at a joint. The hand 44b is provided at a tip of the connection arms 44a, and holds the laminate 6 or the wafer W. The carrying robot 42 allows the laminate 6 or the wafer W to move in a horizontal plane, by the flexible movement of the connection arms 44a and the rotational movement at the axis 42a of the carrying robot 42.

The following description explains the washing means 50.

(Washing Means)

The washing means 50 has a first washing unit 52 and a second washing unit 54.

A main purpose of the first washing unit 52 is to remove the adhesive agent remaining on the wafer W, and a main purpose of the second washing unit 54 is to further wash and thereafter dry the wafer W. As such, it is possible to carry out further high-level washing (washing so as to obtain a clean surface) by providing a plurality of washing units.

The first washing unit 52 includes a washing plate 56 and holder moving means 57 which holds the washing plate 56 and allows movement of the washing plate 56 in a vertical direction. The washing plate 56 is a counter plate which has a surface that faces a side of the wafer W which has been processed. The surface that faces this side of the wafer W has a washing liquid supply hole (not illustrated) for supplying the washing liquid to the wafer W and a washing liquid absorbing hole (not illustrated) for absorbing the washing liquid thus supplied. It is preferable for this surface of the washing plate 56 to be substantially same in size as the side of the wafer W to be processed. A whole of the side of the wafer W can thus be washed at once, which as a result can wash the wafer W efficiently and evenly.

The first washing unit 52 sufficiently carries out processing by (i) positioning the wafer W and the washing plate 56 so as to face each other, and (ii) simultaneously supplying (dropping) and absorbing the washing liquid (washing process). This prevents dispersion of the washing liquid to the dicing tape. A preferable solvent from the foregoing solvents may be used as the washing liquid.

Moreover, it is preferable for the first washing unit 52 to include, as similar to the peeling means 30, horizontally moving means 58 which can horizontally move. Having the horizontally moving means 58 in the first washing unit 52 allows the washing plate 56 to standby at a position that does not overlap with the processing board 55 when seen as a plan view. The present embodiment shows an example in which the horizontally moving means 58 has a linear traveling path 58a and a movement mechanism along the traveling path 58a. However, as long as the washing plate 56 can move between a standby position and a processing position, the horizontally moving means is not limited to this.

The second washing unit 54 further washes the wafer W which has been washed in the first washing unit 52, and in the end dries the wafer W. The second washing unit 54 is not particularly limited, as long as it includes an arrangement for carrying out cup washing.

The wafer W is carried from the first washing unit 52 to the second washing unit 54 by the carrying means 40. The wafer W which has been washed by the second washing unit 54 is held by the carrying means 40, and carried to the removal means 60.

The processings carried out until this step by the peeling means 30 and the washing means 50 peels off the support plate 2 from the side W-a of the wafer W, and further removes the adhesive agent layer 3 provided between the support plate 2 and the wafer W to a certain degree from the side W-a of the wafer W from which the support plate 2 has been peeled off. However, the inventors of the present invention found that there remains, on the side W-a of the wafer W from which the support plate 2 has been peeled off, an adhesive agent that is derived from the adhesive layer 3 that cannot be removed by the washing liquid, and that this adhesive agent impedes the enhancement in performance of the wafer W. In regards to this, the removal means 60 illustrated in FIG. 3 is provided to the arrangement; this enables successful removal of the adhesive agent that remains on the side W-a from which the support plate 2 has been peeled off. As such, the present invention is accomplished.

(Removal Means)

The removal means 60 removes, by dry processing, the adhesive agent that remains on the side W-a of the wafer W from which the support plate 2 has been peeled off, after the side W-a of the wafer W has been washed by the washing means 50.

As illustrated in FIG. 4, the removal means 60 is arranged such that plasma processing is carried out to the side W-a of the wafer W, after the side W-a is washed by the washing means 50.

More specifically, the removal means generate oxygen plasma for removing the adhesive agent that remains on the side W-a of the wafer W (removal processing). The present invention is not limited to the oxygen plasma, however it is preferable to use the oxygen plasma due to its high removal efficiency.

Once the adhesive agent that remains on the side W-a of the wafer W is removed by the removal means, the wafer W is diced by a dicing apparatus, so as to form individual chips.

The support plate peeling apparatus of the present embodiment may further include an alignment section 71, as illustrated in FIG. 3. The alignment section 71 aligns the laminate 6 taken out from the laminate containing section 20, before the laminate 6 is carried to the peeling means 30. The alignment section 71 aligns the laminate 6 so that the laminate 6 is positioned at a suitable position in the peeling means 30. Positioning of the alignment section 71 along the traveling path 46 of the carrying means 40 (so as to face the traveling path 46) allows determination of position with respect to three points: a traveling direction of the robot (X); an extending direction of the arm (Y); and a rotation of the robot (θ). This allows highly accurate position determination, and therefore is preferable. It is also preferable to place the alignment section 71 on a line extending from the traveling path 46 of the carrying means 40, in view of advantages such as space efficiency. Furthermore, it is preferable to place the alignment section 71 on the line extending from the traveling path 46 of the carrying means 40 so that when the laminate 6 is carried to the peeling means, the laminate 6 is positioned such that the plurality of peeling means are positioned away from the laminate 6 by equal distances.

The following description explains the present embodiment in details, based on an example. Note that the arrangement of the present invention is not limited to the following arrangement.

### EXAMPLE (1)

As one example of the support plate peeling apparatus in accordance with the present embodiment, washing processing and removal processing were carried out by the method as follows, and residue that remained on a side of a wafer thus processed was evaluated.

(1-1) Laminate

In the present Example, a bare silicon substrate having a diameter of 200 mm was used as a wafer W illustrated in FIG. 1(b). On one side of the bare silicon substrate, an acrylic adhesive agent was applied so as to form an adhesive agent layer 3 (FIG. 1(b)) having a layer thickness of 15 μm. For convenience, the dicing tape 4 and the dicing frame 5 illustrated in FIG. 1(b) were not used in the present Example.

Moreover, in the present Example, a bare silicon substrate on which one side has been washed with the washing liquid was used as the laminate. Therefore, the support plate 2 in FIG. 1(b) was also not used, and the silicon substrate has not been reduced in thickness.

(1-2) Washing Means

PGMEA, which was used as the washing liquid, was dropped (30 ml/min) on a center part of a surface of the laminate on which the adhesive agent layer 3 was formed. The laminate was thereafter spin washed, which was carried out while spinning the laminate. The spinning was carried out by (i) placing, on a rotating table, a side of the laminate opposite to the side on which the adhesive layer 3 is formed, and (ii) rotating the laminate at an axis along a thickness direction of the laminate. The washing was carried out for five minutes.

(1-3) Removal Means

Oxygen plasma processing was carried out by use of removal means. The oxygen plasma processing was carried out under conditions in a processing room of: a temperature at 60° C., a degree of vacuum at 63 Pa, gaseous oxygen of 1 L/min, and an RF output of 300 W. This processing was carried out for 1 minute.

An adhesive residue remaining on one side of the bare silicon substrate that was obtained by having the bare silicon substrate be subjected to the aforementioned processings were evaluated by carrying out a surface analysis of a spot size of 800 μm with an X-ray photoelectron spectroscopic analysis apparatus (XPS). In the present Example, residue carbon on one side of the bare silicon substrate was measured by the XPS.

Table 1 shows an oxygen plasma processing time dependency of a peak strength around 285 eV. This peak strength is where a peak of carbon (organic material) derived from an adhesive agent is apparent. It was verified by Table 1 that, it is possible to remove, in one minute since start of the processing, substantially all of the residue by carrying out oxygen plasma processing in the removal means of the present Example. This means that the support plate is peeled off from the wafer reduced in thickness and fixed to a dicing tape as illustrated in FIG. 1(a) and FIG. 1(b) by use of a solvent; and residue of an adhesive agent which could not be completely removed by washing the wafer with a washing liquid can be removed from the wafer.

TABLE 1

| Processing | Peak Strength |
|---|---|
| Only washing liquid | 24863 |
| Washing liquid + oxygen plasma (1 min.) | 645 |

As described above, with the support plate peeling apparatus in accordance with the present embodiment, adhesive agent residue is removable by a simple method that oxygen plasma is supplied to a side of a wafer from which a support plate has been peeled off, which adhesive agent residue could not be completely removed by washing with a washing liquid after the support plate has been peeled off from the wafer reduced in thickness and fixed to a dicing tape, and which support plate is peeled off by melting an adhesive agent layer. This suppresses performance deterioration of the wafer, and contributes in providing a highly reliable wafer.

### Second Embodiment

The following description explains a support plate peeling apparatus as a second embodiment of a supporting plate peeling apparatus according to the present invention, with reference to the attached drawings.

Removal means provided in the support plate peeling apparatus of First Embodiment is arranged such that plasma processing is carried out to a side of a wafer from which a support plate has been peeled off. In comparison, removal means provided in the support plate peeling apparatus of the present embodiment is arranged such that ozone processing is carried out to such side of the wafer. Explanations of any other arrangements are omitted; only an arrangement of the removal means is explained below.

The ozone processing denotes a processing which generates ozone, decomposes the ozone to generate active oxygen, then decomposes and removes an adhesive agent remaining on the side of the wafer from which the support plate has been peeled off by the active oxygen. A method for generating the ozone is not particularly limited, and oxygen contained in air of a processing room may be converted to ozone by radiating ultraviolet rays, or ozone may be directly introduced into the processing room by use of an ozone supplying apparatus.

In a case where an arrangement to generate active oxygen by use of an ultraviolet (UV) lamp is used as the removal means provided in the support plate peeling apparatus, it is preferable to use a UV lamp that can radiate ultraviolet rays having a wavelength in a range of 172 nm to 300 nm.

The following description explains the present embodiment in details, based on an example. The arrangement of the present invention is not limited to the following arrangement.

### EXAMPLE (2)

Washing processing and removal processing were carried out in the following method as one example of the support plate peeling apparatus according to the present embodiment, and residue on a surface of the wafer thus processed was evaluated.

(2-1) Laminate

The present Example uses a laminate which has the same arrangements as the laminate in Example (1), except that, as the wafer W illustrated in FIG. 1(b), a silicon wafer having a diameter of 150 mm, on which aluminum is deposited by vacuum sputtering, is used instead of the bare silicon substrate described in Example (1).

(2-2) Washing Means

The same conditions as Example (1) were applied for the washing by the washing means.

(2-3) Removal Means

Ozone processing was carried out by the removal means. The ozone processing was carried out by use of an UV Ozone Cleaning System (model UV-208, manufactured by Technovision, Inc.), by placing the laminate inside the system (processing room) and carrying out the ozone processing therein. The processing room was made at room temperature. In the ozone processing, ozone was generated and decomposed by radiation of UV rays of two wavelengths. The removal of residue on the laminate was carried out by use of active oxygen generated by this radiation. More specifically, ozone was generated by radiating UV rays having a wavelength of 185 nm in the processing room as a first stage. Subsequently, the ozone was decomposed by radiation of UV rays having a wavelength of 254 nm as a second stage, so as to generate the active oxygen.

Adhesive agent residue on one side of the aluminum surface film wafer was evaluated similarly to Example (1), by carrying out surface analysis for a spot size of 800 μm with the X-ray photoelectron spectroscopic analysis apparatus (XPS).

Table 2 shows an ozone processing time dependency of a peak strength around 285 eV. This peak strength is where a peak of carbon (organic material) derived from an adhesive agent is apparent. It was verified by Table 2 that, it is possible to remove, in two minutes since start of the processing, substantially all of the residue by carrying out ozone processing by the removal means of the present Example. This means that the support plate is peeled off from the wafer reduced in thickness and fixed to a dicing tape as illustrated in FIG. 1(a) and FIG. 1(b) by use of a solvent; and residue of an adhesive agent which could not be completely removed by washing the wafer with a washing liquid can be removed from the wafer.

TABLE 2

| Processing | Peak Strength |
|---|---|
| only washing liquid | 23114 |
| Washing liquid + ozone processing (2 mins.) | 7044 |
| Washing liquid + ozone processing (3 mins.) | 5138 |
| Washing liquid + ozone processing (5 mins.) | 2696 |
| Washing liquid + ozone processing (30 mins.) | 2247 |

As described above, with the support plate peeling apparatus in accordance with the present embodiment, adhesive agent residue is removable by a simple method of ozone processing, which adhesive agent residue could not be completely removed by washing with a washing liquid after the support plate has been peeled off from the wafer reduced in thickness and fixed to a dicing tape, and which the support plate is peeled off by melting an adhesive agent layer. This suppresses performance deterioration of the wafer, and contributes in providing a highly reliable wafer.

### Third Embodiment

The following description explains a support plate peeling apparatus as a third embodiment of a supporting plate peeling apparatus according to the present invention.

The removal means provided in the support plate peeling apparatus of First Embodiment is arranged so as to carry out plasma processing to the side of the wafer from which the support plate has been peeled off. In comparison, the removal means provided in the support plate peeling apparatus of the present embodiment carries out ultraviolet ray processing to the side of the wafer from which the support plate has been peeled off. Explanations of other arrangements are omitted, and just the arrangement of the removal means is explained below.

The ultraviolet ray processing is a processing which removes the adhesive agent remaining on a side of the wafer from which the support plate has been peeled off, by radiating ultraviolet (UV) rays from an ultraviolet radiation apparatus (for example, a UV lamp) to such side of the wafer.

In Second Embodiment, an arrangement was explained such that ozone was generated by ultraviolet ray radiation, and the adhesive agent which remains on the side of the wafer from which the support plate has been peeled off was decomposed and removed by active ozone, which active ozone was generated by decomposition of the ozone. The removal means of the present embodiment includes the arrangement of decomposing and removing the adhesive agent remaining on the side of the wafer from which the support plate has been peeled off in the same mechanism as the ozone processing by radiating UV, however also includes an arrangement where the adhesive agent is removed by radiating UV rays under a condition in which ozone and active oxygen do not generate.

That is to say, the removal means provided in the support plate peeling apparatus of the present embodiment has a UV lamp. The UV lamp may be provided inside the processing room which contains the laminate which has the wafer that has been washed with a washing liquid, or the UV lamp may be provided externally to a window of the processing room. In this way, UV rays can be radiated to the side of the wafer from which the support plate has been peeled off or the vicinity of such side of the wafer.

It is preferable for the UV lamp to be capable of radiating UV rays having a wavelength in a range of 172 nm to 300 nm.

As described above, with the support plate peeling apparatus in accordance with the present embodiment, adhesive agent residue is removable by a simple method of UV processing, which adhesive agent residue could not be completely removed by washing with a washing liquid after the support plate has been peeled off from the wafer reduced in thickness and fixed to a dicing tape, and which the support plate is peeled off by melting an adhesive agent layer. This suppresses performance deterioration of the wafer, and contributes in providing a highly reliable wafer.

The present invention is not limited to the description of the embodiments above, but may be altered by a skilled person within the scope of the claims. An embodiment based on a proper combination of technical means disclosed in different embodiments is encompassed in the technical scope of the present invention.

### REFERENCE SIGNS LIST

2 support plate (supporting plate)
2a through hole
3 adhesive agent layer
3′ adhesive agent liquid
4 dicing tape
5 dicing frame
6 laminate
10 grinder
20 laminate containing section
30 peeling means
30a melting processing body
30b support plate carrier
32 solvent injection plate
34 holder moving means
36 processing board
38 horizontally moving means
39 standby position
40 carrying means
42 carrying robot
44a connection arm
44b hand
46 traveling path
50 washing means
52 first washing unit
54 second washing unit
55 processing board
56 washing plate
57 holder moving means
58 horizontally moving means
58a traveling path
60 removal means
70 support plate containing section
71 alignment section
80 support plate peeling apparatus (support plate peeling apparatus)
W wafer
W-a side
W-b back side

1. A supporting plate peeling apparatus comprising:
peeling means for peeling off a wafer from a supporting plate, the wafer being adhered to the supporting plate by use of an adhesive agent;
washing means for washing, by use of a solvent, the adhesive agent remaining on a supporting plate side of the wafer from which the supporting plate has been peeled off by the peeling means; and
removal means for removing, by dry processing, the adhesive agent remaining on the supporting plate side of the wafer which has been washed by the washing means.

2. The supporting plate peeling apparatus as set forth in claim 1, wherein the removal means removes the adhesive agent remaining on the supporting plate side of the wafer by treating the supporting plate side of the wafer with ultraviolet ray processing, plasma processing, or ozone processing.

3. The supporting plate peeling apparatus as set forth in claim 2, wherein the removal means is configured to generate oxygen plasma for the plasma processing.

4. The supporting plate peeling apparatus as set forth in claim 1, wherein a dicing tape held by a dicing frame is adhered on a reverse side of the supporting plate side of the wafer, and the wafer has a thickness of more than 0 μm but not more than 150 μm.
